(19) United States
(12) Patent Application Publication
(10) Pub. No.: US 2002/0121836 A1
(43) Pub. Date: Sep. 5, 2002

(54) End shield for a commutator machine and a method for producing such an end shield

(76) Inventors: Wolfgang Winkler, Schutterwald (DE); Gerhard Gross, Lauf (DE); Hartmut Nitzsche, Buehl (DE); Bernhard Merschroth, Ottersweier (DE); andreas Ewert, Lichtenau (DE)

Correspondence Address: Striker, Striker & Stenby, 103 East Neck Road, Huntington, NY, 11743, US

(21) Appl. No.: 10/030,767

(22) PCT Filed: Feb. 20, 2001
(86) PCT No.: PCT/DE01/00636

(30) Foreign Application Priority Data
Feb. 22, 2000 (DE) 100 07 905.9

(51) Int. Cl. H02K 13/00

(52) U.S. Cl. 310/239; 310/71

(57) ABSTRACT

A bearing plate for a commutator machine according to the related art is made of metal and comprises an applied brush holder made of plastic. Connector elements for electrical components on the brush holder are inserted in corresponding receptacles in the brush holder in a separate working step, however. In the bearing plate (1) according to the invention, the connector elements (4, 8, 11) are formed out of the bearing plate and are partially connected to the bearing plate (1), thereby reducing the number of parts to be installed as well as the production expense.

### RELATED ART

The invention is based on a bearing plate for a commutator machine and a method for producing a bearing plate for a commutator machine according to the general class of claim 1 and claims 8, 9.

A bearing plate having a brush holder is made known in DE 42 43 716 A1. The brush holder is applied to the metal bearing plate in an injection-moulding procedure. Connector elements for an external attachment plug or connector elements for a reactor must be produced and installed on the brush holder in a separate work operation.

### ADVANTAGES OF THE INVENTION

In contrast, the bearing plate according to the invention for a commutator machine and the method according to the invention for producing a bearing plate having the characteristic features of claim 1 or claims 8, 9 have the advantage that a number of parts to be installed is reduced in simple fashion and the production method is simplified.

Advantageous further developments and improvements of the bearing plate named in claim 1 and claims 8, 9 and the method for producing the bearing plate are possible due to the measures and process steps listed in the dependent claims 2 through 7 and 10 through 13.

It is advantageous to design at least one connector element as a single piece with the bearing plate, because this reduces a number of parts to be installed.

In order to ensure rapid and cost-effective production, it is advantageous to injection-mould or cast the brush holder onto the bearing plate, because this simplifies the production process.

It is also advantageous to design an electrical attachment plug for the external electrical connections as a single piece with the brush holder, because this reduces a number of parts to be installed and simplifies the production process.

Since elevated temperatures occur during operation in the region of the guide shafts for the brushes, it is advantageous to make these guide shafts out of heat-resistant material, because this increases the life of a brush holder and increases the reliability of a commutator machine.

In order to achieve a low weight and simplified production of the brush holder, it is advantageous to use plastic.

Advantages in the production of the bearing plate with the brush holder result in that an attachment plug is produced in one work operation with the brush holder.

### DIAGRAM

An embodiment of the invention is shown in simplified form in the diagram and is explained in greater detail in the description below.

FIGS. 1a, b show the steps to manufacture a bearing plate, and

FIG. 1c shows a bearing plate according to the invention having connector elements,

FIG. 2 shows a bearing plate according to the invention having connector elements in a further manufacturing step,

FIG. 3 shows a bearing plate according to the invention having a brush holder and a part of a motor housing in an axial cross section,

FIG. 4a shows a top view of a brush holder, and

FIG. 4b shows a sectional drawing along the line B-B in FIG. 4a.

### DESCRIPTION OF THE EMBODIMENT

A commutator machine is used as an electric motor, for example. The electric motor comprises, among other things, a motor housing, a stator, a rotor with commutator, brush holder with brushes to conduct current to the commutator, and at least one bearing plate that closes the motor housing on the front side and, for example, contains a bearing receptacle for a bearing of a rotor shaft.

In a first production step, the bearing plate 1 is punched or cut out of sheet metal (FIG. 1a) or a metal strip, so that it is given the form shown in FIG. 1b, for example.

FIG. 1b shows a crude form-that was just completed-of the metal bearing plate 1 that is round in this example and comprises e.g., four, e.g., long projections for electrically conductive connector elements 4 that extend in the plane of the diagram, for example: e.g., two plug connector elements 8 and, e.g., two reactor-brush connector elements 11. Fewer or more connector elements 4 can be present. The plug connector elements 8 serve as an electrical connection between a commutator of the electric motor and an external attachment plug. External electrical connections are a plug-and-socket connection, for example, as shown in the figures, or terminals for a fixed cable joint are produced by way of soldering or welding. The reactor-brush connector elements 11 serve as electrical connecting piece between an electrical reactor 68 (FIG. 3) and the brush power supply.

FIG. 1c shows the bearing plate 1 in a further manufacturing step. The reactor-brush connector elements 11 are separated from the bearing plate 1 in the direction of their axial extension in the plane of the diagram along one parting line (20) each (indicated with a dashed line in FIG. 1c), so that they are connected to the bearing plate 1 only along one connecting line 23 (indicated with a dot-dashed line in FIG. 1c).

The plug connector elements 8 are also separated from the bearing plate 1 along a parting line 20 (indicated with a dashed line in FIG. 1c) in the direction of its axial extension in the plane of the diagram, and first and second holding sections 30, 33, for example, are formed at each plug connector element 8 by way of further parting lines 21. The blank of the bearing plate 1 is then pressed in a plate-like form, for example, and further bores or holes may then be produced. This sequence of production steps is not absolutely necessary.

In a further production step, the reactor-brush connector elements 11 are bent along a bending line 17 (indicated as a dotted line in FIG. 1c) into their final position, for example, nearly perpendicular to the plane of the bearing plate 1 and possibly into a predetermined form. The reactor-bruch connector elements 11 can also be connected to the bearing plate 1 as separate parts, for example, by way of soldering, for instance. The plug connector elements 8 are also formed into their final form, for example, along a bending line 17 (shown here as a dotted line) (FIG. 2). The holding sections 30, 33 of the plug connector elements 8 are also bent into their final form, for example, e.g., the holding sections 30 perpendicular to the plane of the bearing plate 1 and in the direction of the bearing plate 1, and the holding sections 33 in the opposite direction.

The plug connector elements 8 can also be connected to the bearing plate 1 as separate parts, for example, by way of soldering, for instance. The first holding sections 30 serve to provide an electrical connection for a capacitor between the two plug connector elements 8. The second holding sections 33 serve to provide an electrical connection for a reactor 68 (FIG. 3) and a plug connection element 8. The reactor-brush connector elements 11 have at least one recess 13 on their exposed end, into which a cable—in addition to a lead from the reactor 68—can be inserted and clamped and possibly soldered as well.

The holding sections 30, 33 also have a recess 13 on their exposed end, for example, into which a lead, for instance, can be inserted. A brush holder 62, e.g., made of plastic, glass, or ceramic is placed on the bearing plate and secured there by way of adhesive bonding, caulking, or, if injection moulding of plastic is used, by injection moulding around it. After the bearing plate 1 and the connector elements 4, 8, 11 are formed, injection moulding with plastic, for example, is applied around the bearing plate at least partially, whereby a brush holder 62 (FIG. 3) is formed on the bearing plate 1, and the connector elements 4, 8, 11 are partially encased in plastic.

The mechanical and electrical connection of the reactor-brush connector elements 11 to the bearing plate 1 is then broken in that a first segment 27 of the reactor-brush connector element 11, indicated here as a surface labelled with X's, is removed, e.g., by punching it out. Every reactor-brush connector element 1 is still retained as a single piece on the brush holder 62 by way of the plastic covering encasing it. The mechanical and electrical connection between the plug connector element 8 and the bearing plate 1 is also broken in that a second segment 36, indicated here as a surface labelled with X's, is removed, e.g., by punching it out.

The manner in which and the location at which the connection between the bearing plate 1 and connector elements 4 is broken depends, among other things, on the number of connector elements 4 and/or the form of the brush holder 62. The plug connector elements 8 also remain connected to the brush holder 62 as a single piece nevertheless due to their plastic casing. The bearing plate 1 has a longitudinal axis 40 and a bearing receptacle 43 for a bearing 51 (FIG. 3) of a rotor shaft 53 (FIG. 3) of the commutator machine. Openings 44 are designed as threads, for example, in order to secure the bearing plate to another device using screws. The openings 44 can also be provided as cable glands, for example.

FIG. 2 shows the bearing plate 11 with connector elements 4 that have been bent in accordance with their subsequent arrangement. The same reference numbers for identical or equally-acting parts are used as in the preceding figures. One can see that the connector elements 4, 8, 11 have been formed out of the bearing plate 1 and that they are a single piece with it in this stage of the process. The connector elements 4 can extend either perpendicularly to or in parallel with a surface of the bearing plate 1. The plug connector elements 8 have been bent along five bending lines 17, for example. The plug connector element 8 first extends perpendicularly to the plane of the bearing plate 1 as a first section and then, in a second section, nearly parallel to the plane of the bearing plate 1, which is followed by a section bent nearly in a U shape, the exposed end of which points in the direction of the bearing plate 1 and forms a tab 38. Notches that are bordered by the separating lines 20 are created in the bearing plate 1 when the connector elements 4 are bent. These notches 41 can be closed again by installing the brush holder 62 (FIG. 3).

FIG. 3 shows a bearing plate 1 with brush holder 62 in an axial cross section and, in sections, a direct-current, low-power motor as an example of a commutator machine 46. The commutator machine 46 has a housing 48 that is closed by the bearing plate 1 on the front side. The bearing 51 is secured in the bearing receptacle 43 formed in the bearing plate 1, which bearing 51 accommodates the one end of the rotor shaft 53 of the low-power motor. Although not shown any further, the other end of the rotor shaft 53 is supported in a further bearing in a second bearing plate, for instance, which covers the other front side of the housing 48. Although not shown any further, but which is known, a rotor with an armature winding situated inside it sits on the rotor shaft 53. The exciter field is created by a number of permanent magnets that are secured on the housing 48, which also represents the stator. A drum collector or commutator having a multitude of commutator segments is arranged on the rotor shaft 53 near the bearing plate 1 in such a fashion that they are secure during rotation, which commutator segments are electrically connected to the armature winding by way of their individual terminal lugs. Commutation or commutator brushes, also called brushes 56, are placed against the drum commutator with the aid of preloaded brush springs. The brushes 56 and brush springs are accommodated in tubular brush holders or guide shafts 59 that are arranged in a nearly radial alignment to the commutator axis on the inside surface of the bearing plate 1. Only one guide shaft 59 is shown in FIG. 3 out of at least two nearly diametrically opposed guide shafts 59 on the commutator. The guide shaft is designed as a single piece with the brush holder 62, for example. The area around the guide shafts 59 can be made out of a heat-resistant material like the rest of the brush holder 62, and it can be produced in a tool with the brush holder 62. The commutator brush 56 is connected to the electrical reactor-brush connector element 11 designed as a connector lug by way of a brush lead 65 that is fed through a longitudinal slit in the guide shaft 59, which reactor-brush connector element 11 is encased and held in the material of the brush holder 62. The connection leads from the reactor-brush connector element 11 to the plug connector element 8 by way of the reactor 68 serving as the interference suppression means 68, which reactor 68 is electrically connected with the reactor-brush connector element 11.

The brush holder 62 has been applied to the bearing plate 1 in the injection moulding procedure, for example, in such a fashion that the guide shafts 59, a receptacle 72 for supporting the interference suppression means 68, an attachment plug 75 for the external electrical connections (tabs 38) are designed as a single piece with the brush holder 62, i.e., they have been injection-moulded into place in a single work operation. Injection moulding is thereby applied out around the connector elements 4, such as the plug connector elements 8 and the reactor-brush connector elements 11, for example, and they protrude through the brush holder 62.

Furthermore, the brush holder 62 is designed in such a fashion that it seals off the inside of the housing 48 when placed on the housing 48. Once the brush holder 62 has been placed on the bearing plate 1, the first and second segments 27, 36 described above are punched out. In the case of the segment 27 of the reactor-brush connector element 11, this can take place on the side of the bearing plate 1 opposite to the brush holder 62 without also punching out parts of the brush holder 62 as well.

The interference suppression means 68 is then placed in the receptacle 72 and further components such as a capacitor are installed and necessary electrical connections are established. A circuit of the electrical elements on the brush holder 62 is as follows, for example:

A plug connector element 8 forms the positive pole and is electrically connected to an interference suppression means 68 in that a lead of this interference suppression means 68 has been inserted in the recess 13 of the reactor projection 33. This interference suppression means 68 is electrically connected to the reactor-brush connector element 11 by way of a further lead 79. The reactor-brush connector element 11, in turn, is electrically connected to the brush lead 65, which forms the power supply for the brush 56. Current flows over the commutator to the other brush 56 which, in turn, is electrically connected to the other reactor-brush connector element 11 by way of the other brush lead 65.

The circuit now closes, as described above, in reverse sequence to the other plug connector element 8.

A capacitor 83 (FIG. 4) electrically connects the capacitor connections 30, for example, of the two plug connection elements 8 with each other.

The reactor-brush connector elements 11 are electrically insulated from the bearing plate 1. A plug connector element 8 can be electrically connected with the bearing plate 1, for example, and with the metallic motor housing 48, for example, in that the mechanical connection is not broken.

FIG. 4a shows a top view of a brush holder 62 according to the invention. An interference suppression means, e.g., a capacitor 83, which suppresses interference voltages for radio reception, for example, is secured and electrically bonded between the holding sections 30. In this embodiment, the reactor 68 is not arranged in a receptacle 72, but rather held in its position in that it is held in two fixed locations 33, 11. The guide shaft 59 has a notch 87 in its top side, by way of which the brush lead 65 can be connected to the carbon brush 56.

FIG. 4b shows a section along the line B-B in FIG. 4a. The carbon brush 56 is guided in the guide shaft 59 and pressed against a commutator 90 by a spring (not shown) on its end opposite to the shaft. The carbon brush 56 becomes shorter due to wear, and the brush lead 65 follows it if the notch 87 is designed accordingly along a direction of displacement of the carbon brush 56 toward the shaft 53.

1. Bearing plate (1) made of metal for a commutator machine (46) that has the following features:
i) the bearing plate (1) closes a housing (48) of the commutator machine (46) on the front side,
ii) the bearing plate (1) forms a bearing receptacle (43) for a bearing (51) of a rotor shaft (53) of the commutator machine,
iii) the bearing plate (1) is connected to a brush holder (62), whereby the brush holder (62) has the following features: the brush holder (62), when the bearing plate (1) and housing (48) are in the assembled state, is situated on an inner surface of the bearing plate (1) and is electrically insulating, the brush holder (62) has guide shafts to accommodate one commutator brush (56) each in radially displaceable fashion, characterized in that at least one electrically conductive connector element (4, 8, 11) for electrical components (68) or plugs (76) are formed out of the bearing plate (1).

2. Bearing plate according to claim 1, characterized in that at least one connector element (4, 8, 11) is a single piece with the bearing plate (1).

3. Bearing plate according to claim 1 or 2, characterized in that the brush holder (62) is injection-moulded or cast onto the bearing plate (1) as an integral part of the bearing plate (1).

4. Bearing plate according to one or more of the claims 1 through 3, characterized in that at least one connector element (4, 8, 11) is partially embedded in the brush holder (62) and partially protrudes out of the brush holder (62).

5. Bearing plate according to one or more of the preceding claims 1 through 4, characterized in that an attachment housing (75) for an external electrical connection is designed as a single piece with the brush holder (62)

6. Bearing plate according to one or more of the claims 1, 3 through 5, characterized in that the brush holder (62) is made of a heat-resistant material in the area of the guide shafts (59).

7. Bearing plate according to one of the preceding claims 1, 3 through 6, characterized in that the brush holder (62) is made of plastic.

8. Method for producing a bearing plate (1) out of metal for a commutator machine (46) that has the following features:
i) the bearing plate (1) closes a housing (48) of the commutator machine (46) on the front side,
ii) the bearing plate (1) forms a bearing receptacle (43) for a bearing (51) of a rotor shaft (53) of the commutator machine (46),
iii) the bearing plate (1) is connected to a brush holder (62), whereby the brush holder (62) has the following features:
the brush holder (62), when the bearing plate (1) and housing (48) are in the assembled state, is arranged on an inner surface of the bearing plate (1) and is electrically insulating, the brush holder (62) has guide shafts (59) to accommodate one commutator brush (56) each in radially displaceable fashion, characterized in that the bearing plate (1) with openings (44), the bearing receptacle (43), and connector elements (4, 8, 11) are first made out of sheet metal, then a slit extending through the bearing plate (1) is formed along corresponding parting lines (20) around the connector elements (4), so that each of the connector elements (4) is connected to the bearing plate (1) only along one connecting line (23), then at least one connector element (4) is bent along a bending line (17) out of a plane parallel to the bearing plate (1) into a desired shape to form connector elements (4, 8,11), whereby the connector elements (4) form an angle of up to 90° with this plane, then the brush holder (62) is connected-at least partially encompassing the connector elements (4, 8, 11)—to the bearing plate (1), and then at least one connector element (4, 8,11) is separated at a first section (27), whereby a direct connection with the bearing plate (1) is broken at at least one connector element (4, 8, 11).

9. Method for producing a bearing plate (1) out of metal for a commutator machine (46) that has the following features:
i) the bearing plate (1) closes a housing (48) of the commutator machine (46) on the front side,
ii) the bearing plate (1) forms a bearing receptacle (43) for a bearing (51) of a rotor shaft (53) of the commutator machine (46),
iii) the bearing plate (1) is connected to a brush holder (62), whereby the brush holder (62) has the following features: the brush holder (62), when the bearing plate (1) and housing (48) are in the assembled state, is arranged on an inner surface of the bearing plate (1) and is electrically insulating, the brush holder (62) has guide shafts (59) to accommodate one commutator brush (56) each in radially displaceable fashion, characterized in that the bearing plate (1) with openings (44), and the bearing receptacle (43) are first made out of sheet metal, connector elements (4, 8, 11) are also made out of sheet metal, then the connector elements (4, 8, 11) are connected to the bearing plate (1) in such a fashion that each of the connector elements (4) is connected to the bearing plate (1) along a connecting line (23), then at least one connector element (4) is bent along a bending line (17) out of a plane parallel to the bearing plate (1) into a desired shape to form connector elements (4, 8,11), whereby the connector elements (4) form an angle of up to 90° with this plane, then the brush holder (62) is connected-at least partially encompassing the connector elements (4, 8, 11) to the bearing plate (1) and then at least one connector element (4, 8, 11) is separated at a first section (27), whereby a direct connection with the bearing plate (1) is broken at at least one connector element (4, 8, 11).

10. Method according to claim 8 or 9, characterized in that an attachment housing (75) with the brush holder (62) is produced in one work operation.

11. Method according to one or more of the claims 8 through 10, characterized in that the brush holder (62) is injection-moulded or cast onto the bearing plate (1) out of plastic (2).

12. Method according to one of the claims 8 through 11, characterized in that a heat-resistant plastic is injection-moulded in the region of the guide shafts (59) of the brush holder (62).

13. Method according to one of the claims 8 through 12, characterized in that the brush holder (62)—after it is connected to the bearing plate (1)—is completely assembled in that interference suppression means (68), brushes (56), brush leads (65), capacitors are installed and are connected to the connector elements (4, 8, 11) in electrically conductive fashion.
